(19) United States
(12) Patent Application Publication
(10) Pub. No.: US 2019/0265750 A1
(43) Pub. Date: Aug. 29, 2019

(54) Wearable Interactive Display System

(71) Applicant: Willie Crowder, Albany, NY (US)

(72) Inventor: Willie Crowder, Albany, NY (US)

(21) Appl. No.: 16/288,019

(22) Filed: Feb. 27, 2019

Related U.S. Application Data
(60) Provisional application No. 62/635,992, filed on Feb. 27, 2018.

(51) Int. Cl. G06F 1/16; G09F 21/02; A45F 3/04

(52) U.S. Cl. CPC G06F 1/163; A45F 3/04; G09F 21/02

(57) ABSTRACT

A wearable interactive display system is an apparatus that allows a user to present and communicate information to individuals around the user wearing the apparatus. The apparatus includes a backpack, at least one camera, at least one light source, at last one main smart device, a processor, and a power source. The backpack houses and upholds the at least one camera, the at least one light source, the at least one main smart device, the processor, and the power source. The backpack further includes a main compartment and a tablet compartment. The main compartment houses items and the processor. The tablet compartment houses the at least one main smart device. The tablet compartment includes a flap and a transparent layer. The flap allows the at least one smart device to be easily accessed. The transparent layer allows a display screen to be visible while housed within the tablet compartment.

The current application claims priority to U.S. provisional application Ser. No. 62/635,992 filed on Feb. 27, 2018.

### FIELD OF THE INVENTION

The present invention generally relates to interactive gear. More specifically, the present invention is a wearable interactive display system that allows a user to directly present information and retrieve feedback.

### BACKGROUND OF THE INVENTION

Despite all of the technological advances since outdoor advertising was first developed, much about the process remains exactly the same. Outdoor advertising typically relies simply upon printed images and messages which are intended to communicate information about a product to a consumer. Video and sound technology has not been fully utilized in conjunction with outdoor advertising.

The present invention aims to solve this discrepancy by introducing a new form of outdoor advertising. It is an object of the present invention to provide an apparatus which is intended for use in outdoor advertising and can make full use of modern technologies such as videos with sound, and GPS tracking. It is an object of the present invention to apply these technologies to a wearable item such as a backpack. The present invention is worn by a user who then moves around in a public place, thereby creating a fully mobile advertising platform capable of delivering virtually any kind of advertisement to the public.

### BRIEF DESCRIPTION OF THE DRAWINGS

FIG. 1 is a perspective view of the present invention;

FIG. 2 is a perspective view of the present invention with a tablet compartment opened;

FIG. 3 is a rear side view of the present invention;

FIG. 4 is a schematic view of the electronic connections of the present invention;

FIG. 5 is a schematic view of the electrical connections of the present invention;

FIG. 6 is a schematic view of a first supplementary brace, a second supplementary brace, and a supplementary frame with a backpack of the present invention;

### DETAILED DESCRIPTION OF THE INVENTION

All illustrations of the drawings are for the purpose of describing selected versions of the present invention and are not intended to limit the scope of the present invention.

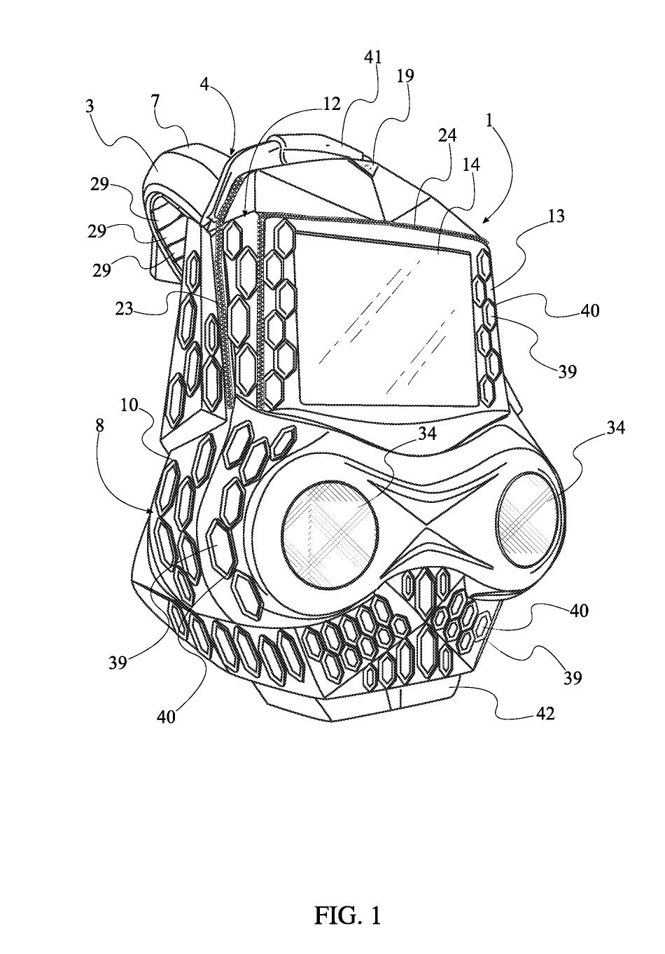

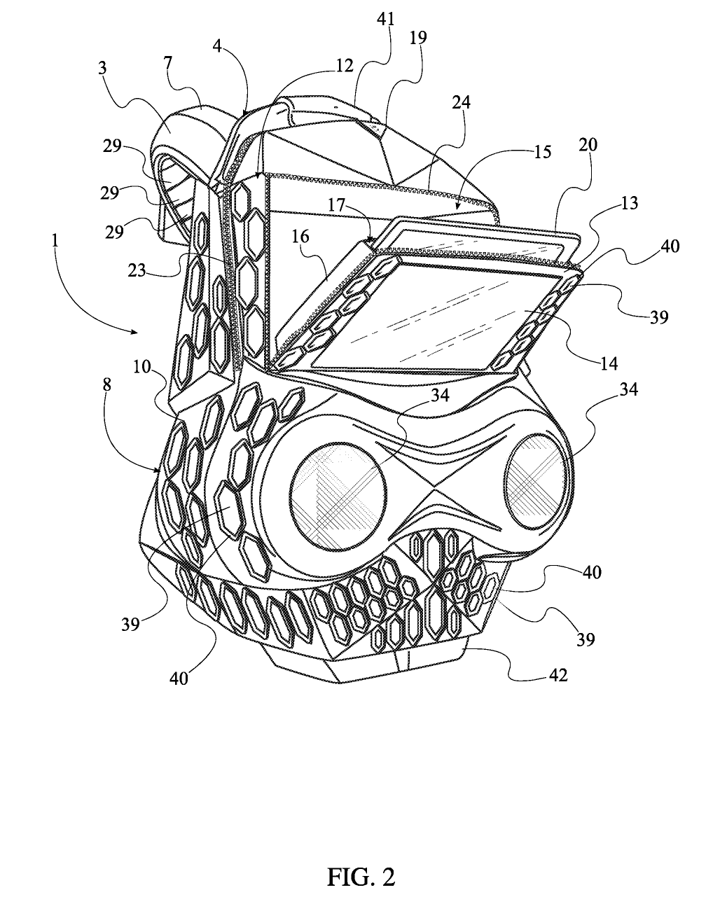

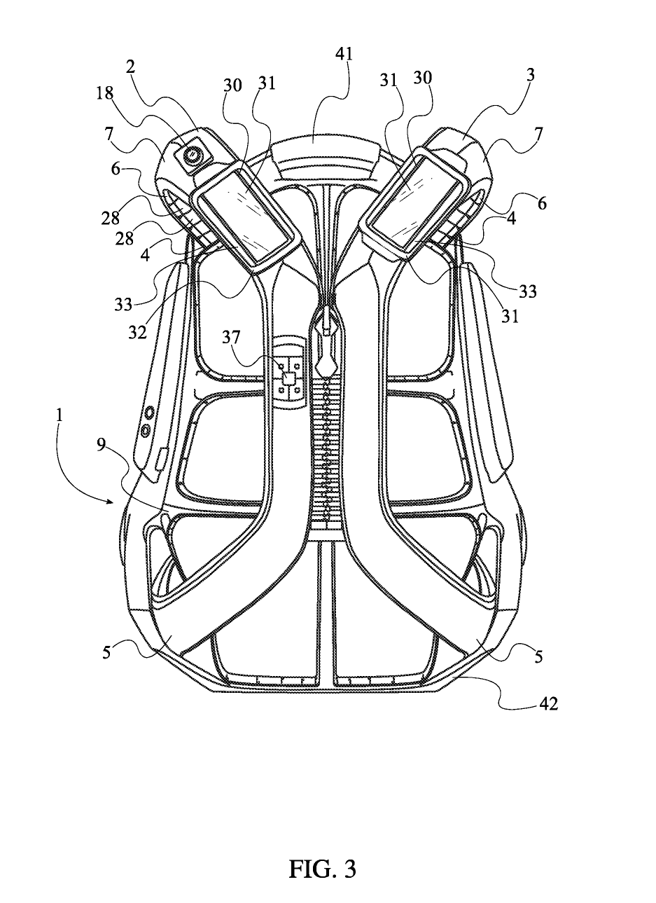

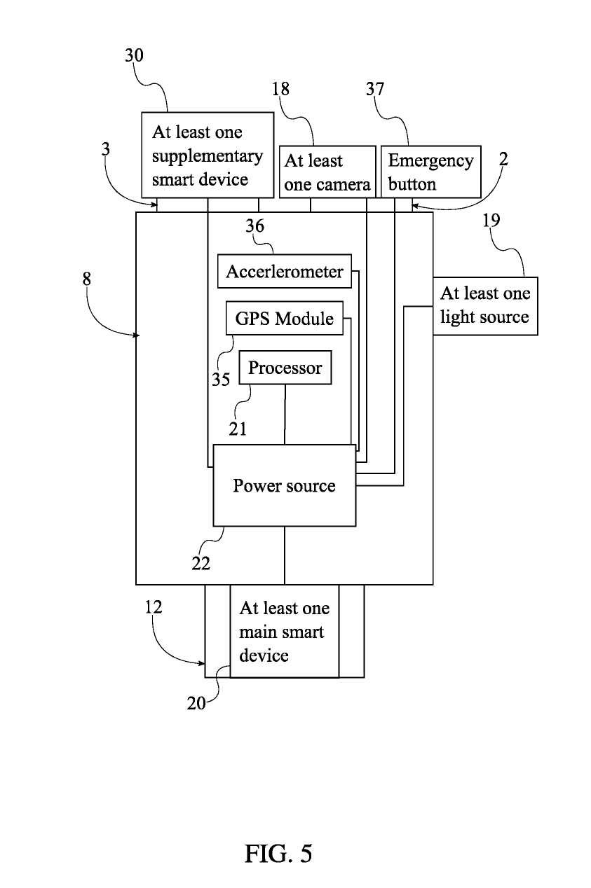

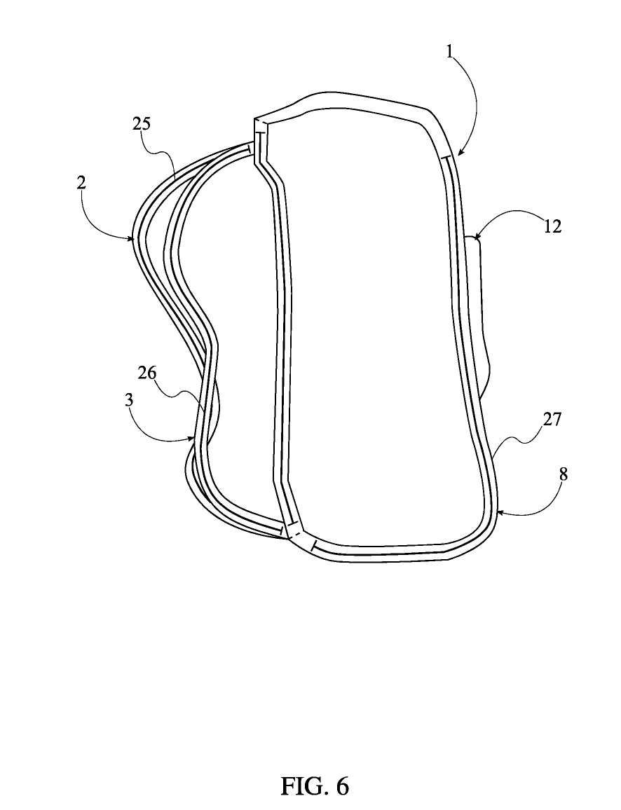

The present invention allows a user to directly control and present information to individuals within the surrounding environment of the present invention. Moreover, the present invention allows a user to communicate from a distance. The present invention preferably allows the user to attract the attention of and present information to individuals within the surrounding environment. The information is preferably a series of advertisements. However, the present invention may alert individuals of an immediate action of the user or of an emergency. In order for individuals within the surrounding environment to receive the desired information, the present invention comprises a backpack 1, at least one camera 18, at least one light source 19, at least one main smart device 20, a processor 21, and a power source 22, seen in FIG. 1, FIG. 2, FIG. 3, FIG. 5, and FIG. 6. The backpack 1 houses a variety of items a user wishes to transport in addition to the at least one main smart device 20, a processor 21, and a power source 22. The backpack 1 comfortably rests on the shoulders and the back of the user as the backpack 1 comprises a first shoulder strap 2, a second shoulder strap 3, a main compartment 8, and a tablet compartment 12. The first shoulder strap 2 and the second shoulder strap 3 uphold the main compartment 8 and the tablet compartment 12 on top of the shoulders of the user while the main compartment 8 rests on the back of the user. The first shoulder strap 2 and the second shoulder strap 3 are preferably length adjustable so that a variety of users may wear the backpack 1. The first shoulder strap 2 and the second shoulder strap 3 each comprises a first end 4 and a second end 5 so that the user may position each arm between the first shoulder strap 2, the second shoulder strap 3, and the main compartment 8. The main compartment 8 houses the processor 21 and the power source 22 and a variety of transportable items. The tablet compartment 12 houses and displays the at least one main smart device 20. In order for the at least one main smart device 20 to be accessible within the tablet compartment 12, the tablet compartment 12 comprises a flap 13. The tablet compartment 12 also comprises a transparent layer 14, thereby allowing a screen 31 of the at least one main smart device 20 to be visible while protected within the tablet compartment 12.

The at least one main smart device 20 is preferably a tablet, as seen in FIG. 2 and FIG. 3, so that the information being presented is viewable by individuals from a further distance from the user wearing the present invention. The at least one main smart device 20 as a tablet also reduces the amount occupied by the at least one main smart device 20 within the tablet compartment 12. The at least one camera 18 transmits and records the reactions and interactions of individuals around the user wearing the present invention. The at least one camera 18 also captures and records the images around the user in real-time in order to for the processor 21 to recreate a 3D view of the surrounding environment of the present invention and the user. The at least one light source 19 visually attracts and alerts individuals around the present invention and the user. The processor 21 controls the electronic components of the present invention and the power source 22 delivers the necessary power to the electronic components. The power source 22 is preferably portable so that the user wearing the present invention is free to move.

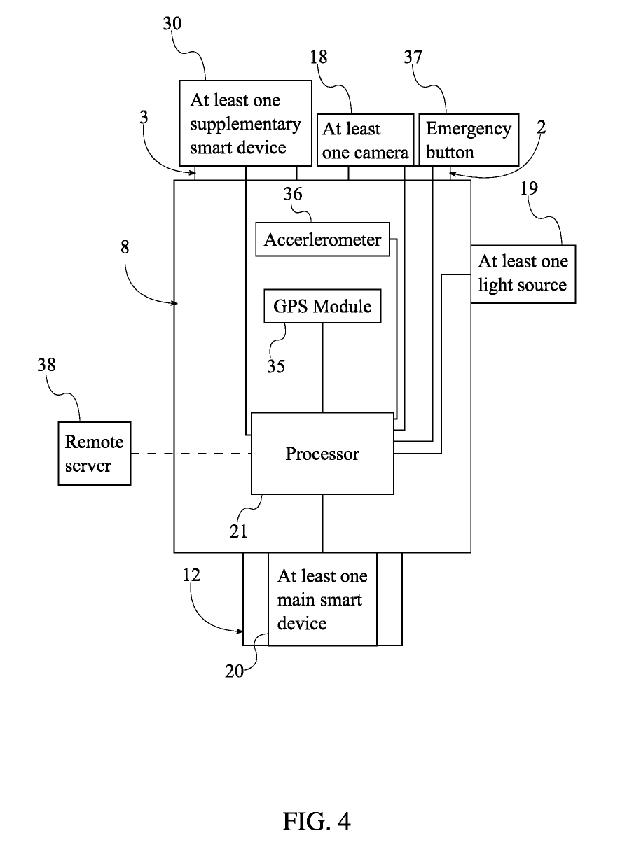

The overall arrangement of the aforementioned components allows the present invention to be interactive with not just the user, but individuals around the present invention. The first end 4 and the second end 5 of both the first shoulder strap 2 and the second shoulder strap 3 are externally connected to a first layer 9 of the main compartment 8, seen in FIG. 4. The first layer 9 presses the back of the user. A second layer 10 of the main compartment 8 is positioned opposite the first layer 9 of the main compartment 8. The second layer 10 shields the items within the main compartment 8 from the surrounding environment. The first layer 9 and the second layer 10 of the main compartment 8 are perimetrically fixed with each other, thereby securely housing a variety of items, the processor 21, and the power source 22. In order for the at least one main smart device 20 to be viewable while housed within the tablet compartment 12, the tablet compartment 12 is fixed adjacent with the second surface 7. More specifically, the flap 13 is hingedly connected with the second surface 7 and, the transparent layer 14 is integrated into the flap 13.

The at least one camera 18 and the at least one light source 19 are able to interact with the surrounding environment as the at least one camera 18 and the at least one light source 19 are externally integrated with the backpack 1, seen in FIG. 1, FIG. 2, FIG. 3, and FIG. 4. In the preferred embodiment of the present invention, the at least one camera 18 comprises a plurality of cameras in order to retrieve a full view of the surrounding environment. More specifically, a first camera is mounted with the first shoulder strap 2, a second camera is mounted with the second shoulder strap 3, and a third camera and a fourth camera are laterally mounted with the main compartment 8, opposite each other. The at least one main smart device 20, the processor 21, and the power source 22 are positioned within the backpack 1. In the preferred embodiment of the present invention, the at least one main smart device 20 is a tablet and is positioned within the tablet compartment 12. Moreover, a screen 31 of the at least one main smart device 20 is positioned adjacent the transparent layer 14. Furthermore, in the preferred embodiment of the present invention, the processor 21 and the power source 22 are positioned within the main compartment 8. In order to control the electronic components of the present invention, the processor 21 is electronically connected with the at least one camera 18, the at least one light source 19, and the at least one main smart device 20. Each electronic component receives the necessary power as the power source 22 is electrically connected with the processor 21, the at least one camera 18, the at least one light source 19, and the at least one main smart device 20.

In order to safely house items within the main compartment 8, the present invention comprises a first elongated fastener 23, seen in FIG. 1, FIG. 2, FIG. 3, and FIG. 4. A first opening 11 of the main compartment 8 traverses into and across the main compartment 8 in order to access the interior of the main compartment 8 and the items within the main compartment 8. The first elongated fastener 23 is operatively coupled with the first opening 11, wherein the first opening 11 of the main compartment 8 is opened and closed with the first elongated fastener 23. In the preferred embodiment of the present invention, the first elongated fastener 23 is a zipper. In various embodiments of the present invention, the first elongated fastener 23 may be a variety of fasteners and the present invention may further comprise a variety of supplementary fasteners that reinforce the closure of the first opening 11. Similarly, the present invention comprises a second elongated fastener 24 in order to safely house items within the tablet compartment 12. A second opening 15 of the tablet compartment 12 traverses into and across the tablet compartment 12 in order to access the interior of the tablet compartment 12 and the items within the tablet compartment 12. The second elongated fastener 24 is operatively coupled with the second opening 15, wherein the second opening 15 of the tablet compartment 12 is opened and closed with the second elongated fastener 24. Similar to the first elongated fastener 23, the second elongated fastener 24 is preferably a zipper. In various embodiments of the present invention, the second elongated fastener 24 may be a variety of fasteners and the present invention may further comprise a variety of supplementary fasteners that reinforce the closure of the second opening 15.

The at least one main smart device 20 is held in place within the tablet compartment 12 as the tablet compartment 12 preferably comprises a pocket 16, shown in FIG. 2 and FIG. 3. The pocket 16 secures the position of the at least one main smart device 20 against the transparent layer 14 in order for the at least one main smart device 20 to continuously display advertisements. The at least one main smart device 20 remains protected as the pocket 16 is positioned within the tablet and is perimetrically connected with the flap 13. The pocket 16 is positioned adjacent the transparent layer 14, so that the display screen 31 of the at least one smart device is continuously visible through the backpack 1. The at least one main smart device 20 is easily positioned within the pocket 16 and accessible from within the pocket 16 as a third opening 17 of the pocket 16 is oriented towards the second opening 15 of the tablet compartment 12. The third opening 17 allows the at least one main smart device 20 may be positioned within the pocket 17.

The backpack 1 is structurally reinforced as the present invention preferably comprises a first supplementary brace 25, a second supplementary brace 26, and a supplementary frame 27, shown in FIG. 7. More specifically, the first supplementary brace 25 and the second supplementary brace 26 structurally reinforce the first shoulder strap 2 and the second shoulder strap 3, respectively. The supplementary frame 27 structurally reinforces the main compartment 8 so that weight of the items within the main compartment 8 does not tear the main compartment 8. In order to support the first shoulder strap 2, the first supplementary brace 25 traverses across and along the first shoulder strap 2. Similarly, the second supplementary brace 26 traverses across and along the second shoulder strap 3. The supplementary frame 27 traverses across and along the main compartment 8, thereby accommodating the structure and form of the main compartment 8 while effectively supporting the main compartment 8. In the preferred embodiment of the present invention, the first supplementary brace 25 and the second supplementary brace 26 are also integrated within the first shoulder strap 2 and the second shoulder strap 3, respectively. Similarly, the supplementary frame 27 is also integrated within the main compartment 8. In this preferred embodiment, the first shoulder strap 2 and the second shoulder strap 3 comfortably rest on the shoulders of the user while being supported by the first supplementary brace 25 and the second supplementary brace 26, respectively.

Alternate embodiments of the present invention may further comprise at least one interconnecting fastener in order to secure the position of the first shoulder strap 2 and the second shoulder strap 3 along the shoulders of the user. As seen in FIG. 4, the at least one interconnecting fastener is preferably a zipper that laterally traverses between the first shoulder strap 2 and the second shoulder strap 3. Moreover, the at least one interconnecting fastener is operatively coupled with the first shoulder strap 2 and the second shoulder strap 3, wherein the first shoulder strap 2 and the second shoulder strap 3 are removably attached with each other.

In order to further enhance the comfort of the user with the present invention, the present invention further comprises a plurality of first impact-resistant pads 28 and a plurality of second impact-resistant pads 29, seen in FIG. 1, FIG. 2, FIG. 3, and FIG. 4. The plurality of first impact-resistant pads 28 and the plurality of second impact-resistant pads 29 are preferably gel patches that relieve the force from the weight of the backpack 1 against the shoulder of the user. The plurality of first impact-resistant pads 28 is distributed along a first surface 6 of the first shoulder strap 2. The first surface 6 of the first shoulder strap 2 directly presses against the user. Moreover, the first surface 6 of the first shoulder strap 2 is positioned adjacent the main compartment 8. The plurality of first impact-resistant pads 28 are connected with the first surface 6 of the first shoulder strap 2, thereby relieving the direct force of the first shoulder strap 2 against the corresponding shoulder of the user. Similarly, the plurality of second impact-resistant pads 29 is distributed along a first surface 6 of the second shoulder strap 3. The first surface 6 of the second shoulder strap 3 is positioned adjacent the main compartment 8. The plurality of second impact-resistant pads 29 is connected with the first surface 6 of the second shoulder strap 3.

As shown in FIG. 1, FIG. 2, FIG. 3, and FIG. 4, the present invention utilizes all aspects of the backpack 1 in order to attract and advertise to individuals positioned all around the user wearing the backpack 1. The present invention further comprises at least one supplementary smart device 30, at least one first supplementary pocket 31, and a transparent layer 33. The at least one first supplementary pocket 31 houses the at least one supplementary smart device 30. The transparent layer 33 allows the at least one supplementary smart device 30 to be viewed through the at least one first supplementary pocket 31. The at least one first supplementary pocket 31 is perimetrically connected to a second surface 7 of the first shoulder strap 2 in order for individuals positioned in front of the user wearing the backpack 1 to be able to view the at least one supplementary smart device 30 from the first shoulder strap 2. More specifically, the second surface 7 of the first shoulder strap 2 is positioned opposite the first surface 6 of the first shoulder strap 2. The transparent layer 33 is integrated within the at least one first supplementary pocket 31, and the at least one supplementary smart device 30 being positioned within the at least one first supplementary pocket 31. This arrangement allows the at least one supplementary smart device 30 to be viewed. Moreover, a screen 31 of the at least one supplementary smart device 30 is positioned adjacent the transparent layer 33. In order to control the screen 31 of the at least one supplementary smart device 30, the at least one supplementary smart device 30 is communicably coupled with the processor 21.

Similarly, for the second shoulder strap 3, the present invention further comprises at least one supplementary smart device 30, at least one second supplementary pocket 32, and a transparent layer 33, seen in FIG. 2 and FIG. 3. The at least one second supplementary pocket 32 houses the at least one supplementary smart device 30. The transparent layer 33 allows the at least one supplementary smart device 30 to be viewed through the at least one second supplementary pocket 32. The at least one second supplementary pocket 32 is perimetrically connected to a second surface 7 of the second shoulder strap 3 in order for individuals positioned in front of the user wearing the backpack 1 to be able to view the at least one supplementary smart device 30 from the second shoulder strap 3. More specifically, the second surface 7 of the second shoulder strap 3 is positioned opposite the first surface 6 of the second shoulder strap 3. The transparent layer 33 is integrated within the at least one second supplementary pocket 32, and the at least one supplementary smart device 30 being positioned within the at least one second supplementary pocket 32. This arrangement allows the at least one supplementary smart device 30 to be viewed. Moreover, a screen 31 of the at least one supplementary smart device 30 is positioned adjacent the transparent layer 33. In order to control the screen 31 of the at least one supplementary smart device 30, the at least one supplementary smart device 30 is communicably coupled with the processor 21.

In order to audibly communicate with individuals surrounding the user wearing the backpack 1, the present invention further comprises at least one speaker 34, shown in FIG. 1, FIG. 2, and FIG. 3. The sound emitted from the at least one speaker 34 is unhindered as the at least one speaker 34 is externally integrated into the second layer 10 of the main compartment 8. The at least one speaker 34 is preferably integrated into the second layer 10 of the main compartment 8, opposite the first shoulder strap 2 and the second shoulder strap 3. The user is able to control the speaker, preferably with the at least one main smart device 20 and the at least one supplementary smart device 30 as the processor 21 is electronically connected with the at least one speaker 34. The speaker receives the necessary power as the power source 22 is electrically connected the at least one speaker 34. Alternate embodiments of the present invention may further comprise a microphone. The microphone allows the user to verbally control the electronic components. In order for the microphone to detect voice commands from the user, the microphone is externally integrated into the second layer 10 of the main compartment 8. Similar to the at least one speaker 34, the processor 21 is electronically connected with the microphone, and the power source 22 is electrically connected with the microphone.

The present invention is able to record and analyze the surrounding environment of the present invention as the present invention further comprises a GPS module 35, shown in FIG. 5 and FIG. 6. The visual recordings of the surrounding environment are associated with a specific area with the at least one camera 18 and the GPS module 35. In order to protect the GPS module 35, the GPS module 35 is positioned within the backpack 1. The GPS module 35 is able to work with the other electronic components of the present invention as the processor 21 is electronically connected with the GPS module 35. The GPS module 35 receives the necessary power from the power source 22 as the power source 22 is electrically connected with the GPS module 35.

Furthermore, the present invention enhances the safety of the user wearing the backpack 1 as the present invention preferably comprises an accelerometer 36, shown in FIG. 5 and FIG. 6. The accelerometer 36 monitors the speed of the user so that in the event of an immediate stop while moving at a high speed, the at least one light source 19 flashes and alerts the individuals around the user wearing the present invention. The accelerometer 36 is safely housed as the accelerometer 36 is positioned within the backpack 1. The processor 21 is electronically connected with the accelerometer 36, thereby activating the at least one light source 19 depending on the speed of the user with the present invention. The power source 22 is electrically connected with the accelerometer 36 in order to deliver the necessary power to the accelerometer 36.

The safety of the user is enhanced while wearing the present invention as the present invention further comprises an emergency button 37, shown in FIG. 4, FIG. 5, and FIG. 6. The emergency button 37 activates the at least one camera 18, the at least one light source 19, the at least one speaker 34, and the GPS module 35. The user is able to easily and quickly access the emergency button 37 as the emergency button 37 is mounted onto the first shoulder strap 2. Alternate embodiments of the present invention may comprise an emergency button 37 that is mounted onto the second shoulder strap 3. The processor 21 is electronically connected with the emergency button 37 so that the at least one camera 18 is activated and records the surrounding environment of the user, the at least one light source 19 is flashes similar to that of an emergency light, and the at least one speaker 34 emits a sound similar to that of an alarm. The GPS module 35 delivers the exact location of the user wearing the backpack 1 to a police department or comparable authorities as the process is communicably coupled with a remote server 38. The remote server 38 is preferably integrated into an alert system of a nearby police department. The emergency receives the necessary power as the power source 22 is electrically connected with the emergency button 37.

In the preferred embodiment of the present invention, the power source 22 is at least one solar panel. The at least one solar panel harnesses the sunlight that comes into contact with the present invention, specifically the at least one solar panel, and converts the energy into power. In various embodiments of the present invention, the at least one solar panel is a supplementary power source to a portable battery or a comparable battery source. Furthermore, the at least one solar panel is integrated with the transparent layer 14 of the tablet compartment 12 and is transparent in order for the display screen 31 of the at least one main smart device 20 is visible from within the tablet compartment 12. In an alternate embodiment of the present invention, the power source 22 may be a motion power generator. The motion power generator may comprise a couple of rails that slidably engage the main compartment 8 with the first shoulder strap 2 and the second shoulder strap 3. The motion power generator harnesses the energy from the upwards and downwards motion of the main compartment 8 as the user moves while wearing the present invention.

The visual attraction of the present invention is enhanced as the preferred embodiment of the present invention further comprises a plurality of display screens 39 and a plurality of frames 40, seen in FIG. 1, FIG. 2, FIG. 3, and FIG. 4. The plurality of display screens 39 generates and emits a cohesive image that encompasses the exterior of the main compartment 8 and the tablet compartment 12. The plurality of frames 40 connects the plurality of display screens 39 with each other and with the main compartment 8, preferably the second layer 10 of the main compartment 8 and the tablet compartment 12. The plurality of frames 40 allows the plurality of display screens 39 to accommodate the structure of the main compartment 8. Each of the display screens of the plurality of display screens 39 are removably coupled with a corresponding frame of the plurality of frames 40. This arrangement allows the plurality of display screens 39 to be easily replaced or repaired. The plurality of frames 40 visually attracts individuals surrounding the present invention as the plurality of frames 40 is externally integrated with the second layer 10 of the main compartment 8 and the tablet compartment 12. A continuous image is presented with the plurality of display screens 39 as the plurality of frames 40 is distributed across the second layer 10 of the main compartment 8 and the tablet compartment 12. In order for the user to control the image presented with each display screen 31 of the plurality of display screen 31, and consequently the overall image across the second layer 10 of the main compartment 8, the processor 21 is electronically connected with the plurality of display screens 39. Each display screen 31 of the plurality of the display screens 39 receives the necessary power to display images as the power source 22 is electrically connected with the plurality of display screens 39.

In the preferred embodiment of the present invention the backpack 1 comprises waterproof materials. The waterproof materials protect the interior of the backpack 1 as well as the electronic components of the present invention. Furthermore, the backpack 1 comprises bulletproof materials in order to protect the items within the backpack 1 and the electronic components of the present invention from direct impact or blunt force. More specifically, the bulletproof materials are preferably a layer combination Dyneema, graphene-infused resin, and Line-X.

In various embodiments of the present invention the first layer 9 and the second layer 10 of the backpack 1 may comprise a plurality of layers in order to enhance the durability of the backpack 1. In these various embodiments of the present invention, the second layer 10 may comprise an exterior layer and a plurality of supplementary layers. The plurality of displayer screens 39 is integrated with the exterior layer, and the plurality of supplementary layers may comprise a combination of the bulletproof layer, the waterproof layer, and the supplementary frame 27.

In order to easily maneuver the backpack 1, the present invention further comprises a handle 41 and a skid plate 42, seen in FIG. 1, FIG. 2, FIG. 3, and FIG. 4. The handle 41 allows a user to lift the backpack 1 without carrying the backpack 1 on the shoulders of the user with the first shoulder strap 2 and the second shoulder strap 3. The skid plate 42 prevents the main compartment 8 from getting damaged while resting on a surface like the ground. The handle 41 is externally fixed with the second layer 10 of the main compartment 8. The handle 41 is preferably positioned adjacent and in between the first end 4 of both the first shoulder strap 2 and the second shoulder strap 3. The skid plate 42 is fixed with the second layer 10 of the main compartment 8. The skid plate 42 is positioned adjacent the second end 5 of both the first shoulder strap 2 and the second shoulder strap 3 to be positioned between the main compartment 8 and a surface. More specifically, the skid plate 42 laterally traverses across the second layer 10 of the main compartment 8. Alternate embodiments of the present invention may further comprise a couple of retractable wheels in order to ease the maneuvering of the present invention while not worn by the user. The couple of retractable wheels are preferably mounted with the main compartment 8 and traverse through the skid plate 42. Alternate embodiments of the present invention may further comprise a plurality of light reflective strips in order to enhance the safety of the present invention. The plurality of light reflective strips is externally fixed with the main compartment 8, thereby allowing light of the surrounding environment to come into contact with the plurality of reflective strips.

Although the invention has been explained in relation to its preferred embodiment, it is to be understood that many other possible modifications and variations can be made without departing from the spirit and scope of the invention as hereinafter claimed.

What is claimed is:

1. A wearable interactive display system comprises:
a backpack;
at least one camera;
at least one light source;
at least one main smart device;
a processor;
a power source;
the backpack comprises a first shoulder strap, a second shoulder strap, a main compartment, and a tablet compartment;
the first shoulder strap and the second shoulder strap each comprises a first end and a second end;
the tablet compartment comprises a flap and a transparent layer;
the first end and the second end of both the first shoulder strap and the second shoulder strap being externally connected to a first layer of the main compartment;
a second layer of the main compartment being positioned opposite the first layer of the main compartment;
the first layer and the second layer of the main compartment being perimetrically fixed with each other;
the tablet compartment being fixed adjacent with the second surface;
the flap being hingedly connected with the second surface;
the transparent layer being integrated into the flap;
the at least one camera and the at least one light source being externally integrated with the backpack;
the at least one main smart device, the processor, and the power source being positioned within the backpack;
the processor being electronically connected with the at least one camera, the at least one light source, and the at least one main smart device; and,
the power source being electrically connected with the processor, the at least one camera, the at least one light source, and the at least one main smart device.

2. The wearable interactive display system as claimed in claim 1 comprises:
a first elongated fastener;
a first opening of the main compartment traversing into and across the main compartment; and,
the first elongated fastener being operatively coupled with the first opening, wherein the first opening of the main compartment is opened and closed with the first elongated fastener.

3. The wearable interactive display system as claimed in claim 1 comprises:
a second elongated fastener;
a second opening of the tablet compartment traversing into and across the tablet compartment; and,
the second elongated fastener being operatively coupled with the second opening, wherein the second opening of the main compartment is opened and closed with the second elongated fastener.

4. The wearable interactive display system as claimed in claim 1 comprises:
the tablet compartment comprises a pocket;
the pocket being positioned within the tablet compartment;
the pocket being perimetrically connected with the flap;
the pocket being positioned adjacent the transparent layer; and,
a third opening of the pocket being oriented towards a second opening of the tablet compartment.

5. The wearable interactive display system as claimed in claim 1 comprises:
a first supplementary brace;
a second supplementary brace;
a supplementary frame;
the first supplementary brace traversing across and along the first shoulder strap;
the second supplementary brace traversing across and along the second shoulder strap;
the supplementary frame traversing across and along the main compartment;
the first supplementary brace being integrated within the first shoulder strap;
the second supplementary brace being integrated within the second shoulder strap; and,
the supplementary frame being integrated within the main compartment.

6. The wearable interactive display system as claimed in claim 1 comprises:
a plurality of first impact-resistant pads;
a plurality of second impact-resistant pads;
the plurality of first impact-resistant pads being distributed along a first surface of the first shoulder strap;
the first surface of the first shoulder strap being positioned adjacent the main compartment;
the plurality of first impact-resistant pads being connected with the first surface of the first shoulder strap;
the plurality of second impact-resistant pads being distributed along a first surface of the second shoulder strap;
the first surface of the second shoulder strap being positioned adjacent the main compartment; and,
the plurality of second impact-resistant pads being connected with the first surface of the second shoulder strap.

7. The wearable interactive display system as claimed in claim 1 comprises:
at least one supplementary smart device;
at least one first supplementary pocket;
a transparent layer;
the at least one first supplementary pocket being perimetrically connected to a second surface of the first shoulder strap;
the second surface of the first shoulder strap being positioned opposite a first surface of the first shoulder strap;
the first surface of the first shoulder strap being positioned adjacent the main compartment;
the transparent layer being integrated within the at least one first supplementary pocket;
the at least one supplementary smart device being positioned within the at least one first supplementary pocket;
a screen of the at least one supplementary smart device being positioned adjacent the transparent layer; and,
the at least one supplementary smart device being communicably coupled with the processor.

8. The wearable interactive display system as claimed in claim 1 comprises:
at least one supplementary smart device;
at least one second supplementary pocket;
a transparent layer;
the at least one second supplementary pocket being perimetrically connected to a second surface of the second shoulder strap;
the second surface of the second shoulder strap being positioned opposite a first surface of the second shoulder strap;
the first surface of the second shoulder strap being positioned adjacent the main compartment;
the transparent layer being integrated within the at least one second supplementary pocket;
the at least one supplementary smart device being positioned within the at least one second supplementary pocket;
a screen of the at least one supplementary smart device being positioned adjacent the transparent layer; and,
the at least one supplementary smart device being communicably coupled with the processor.

9. The wearable interactive display system as claimed in claim 1 comprises:
at least one speaker;
the at least one speaker being externally integrated into the second layer of the main compartment;
the processor being electronically connected with the at least one speaker; and,
the power source being electrically connected with the at least one speaker.

10. The wearable interactive display system as claimed in claim 1 comprises:
a GPS module;
the GPS module being positioned within the backpack;
the processor being electronically connected with the GPS module; and,
the power source being electrically connected with the GPS module.

11. The wearable interactive display system as claimed in claim 1 comprises:
an accelerometer;
the accelerometer being positioned within the backpack;
the processor being electronically connected with the accelerometer; and,
the power source being electrically connected with the accelerometer.

12. The wearable interactive display system as claimed in claim 1 comprises:
an emergency button;
a GPS module;
the emergency button being mounted onto the first shoulder strap;
the GPS module being positioned within the backpack;
the processor being electronically connected with the emergency button and the GPS module;
the processor being communicably coupled with a remote server; and,
the power source being electrically connected with the emergency button and the GPS module.

13. The wearable interactive display system as claimed in claim 1 comprises:
the power source being at least one solar panel; and,
the at least one solar panel being externally integrated with the backpack.

14. The wearable interactive display system as claimed in claim 1 comprises:
a plurality of display screens;
a plurality of frames;
each of the display screens of the plurality of display screens being removably coupled with a corresponding frame of the plurality of frames;
the plurality of frames being externally integrated with the second layer of the main compartment and the tablet compartment;
the plurality of frames being distributed across the second layer of the main compartment and the tablet compartment;
the processor being electronically connected with the plurality of display screens; and,
the power source being electrically connected with the plurality of display screens.

15. The wearable interactive display system as claimed in claim 1, wherein the backpack comprises waterproof materials.

16. The wearable interactive display system as claimed in claim 1, wherein the backpack comprises bulletproof materials.

17. The wearable interactive display system as claimed in claim 1 comprises:
a handle;
the handle being externally fixed with the second layer of the main compartment; and,
the handle being positioned adjacent and between the first end of both the first shoulder strap and the second shoulder strap.

18. The wearable interactive display system as claimed in claim 1 comprises:
a skid plate;
the skid plate being fixed with the second layer of the main compartment;
the skid plate being positioned adjacent the second end of both the first shoulder strap and the second shoulder strap; and,
the skid plate laterally traversing across the second layer of the main compartment.
